(19) United States
(12) Patent Application Publication
(10) Pub. No.: US 2006/0169300 A1
(43) Pub. Date: Aug. 3, 2006

(54) Method of and apparatus for heating liquid used in the manufacturing of semiconductor devices, and method of processing substrates with heated liquid

(76) Inventors: Duk-Min Ahn, Suwon-si (KR); Seung-Kun Lee, Suwon-si (KR); Chang-Hyeon Nam, Osan-si (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/328,098

(22) Filed: Jan. 10, 2006

(30) Foreign Application Priority Data
Jan. 28, 2005 (KR) 2005-0008153

(51) Int. Cl. B08B 3/10

(52) U.S. Cl. 134/1; 134/10; 134/18; 134/19; 134/108; 134/56 R; 134/113

(57) ABSTRACT

Liquid used in manufacturing a semiconductor device is rapidly heated to a desired temperature at which the liquid is most effective at processing substrates. An apparatus for heating the liquid includes a chemical bath in which the liquid is stored, circulation piping connected to the chemical bath, so that the liquid can be circulated in a loop to and from the bath, and a heating system that includes a heating unit associated with the chemical bath and a heating unit associated with the circulation piping. Accordingly, the liquid present in the chemical bath and the liquid flowing through the circulation piping can be heated at the same time. Thus, the temperature of the liquid can be rapidly raised to a desired temperature suitable for the processing of the substrates.

### BACKGROUND OF THE INVENTION

1. Field of the Invention

The present invention relates to the wet processing of substrates, such as semiconductor substrates. More particularly, the present invention relates to a method of and apparatus for heating liquid used, for example, for cleaning a semiconductor substrate.

2. Description of the Related Art

In general, a semiconductor device is manufactured by is repeatedly subjecting a pure silicon wafer to a series of unit processes, such as a photolithography process, an etching process, a thin film deposition process, an ion injection process, and a metal deposition process. However, the yield and reliability of semiconductor devices is significantly affected by impurities, including minute particles, generated during the course of performing such processes. Thus, during most manufacturing sequences, the wafer is cleaned before and after each unit process.

The wafer cleaning process that is now most commonly employed is a wet cleaning process. In the wet cleaning process, a bath containing chemicals and a bath containing ultra pure water are prepared. Then a batch of wafers is simultaneously immersed into the bath containing the chemicals to clean the wafers. Finally, the batch of wafers is immersed into the bath containing the ultra pure water to rinse and hence, finalize the cleaning of the wafers.

Meanwhile, the effectiveness of the liquid used in cleaning the wafers varies considerably according to temperature. Therefore, the chemicals and/or the ultra pure water used in the wet cleaning process is/are heated to a predetermined temperature, e.g., 70° C. ˜163° C., at which the chemicals and/or the ultra pure water are most effective for cleaning the wafers.

A conventional apparatus for heating the liquid used in a process for cleaning semiconductor substrates includes a pipe in which halogen lamps are disposed. The pipe is connected to the chemical bath such that liquid in the chemical bath can be circulated through the pipe and returned to the bath. Thus, the halogen lamps disposed in the pipe heat increase the temperature of the chemicals as the chemicals circulate through the pipe. As a result, all of the chemicals stored in the chemical bath reach a desired temperature after the chemicals have been circulating through the pipe for a certain period of time.

However, the halogen lamps take a considerable amount of time to heat chemicals to a temperature suitable for effectively cleaning semiconductor substrates. In addition, the conventional apparatus requires a considerable amount of time to heat the entire body of chemicals stored in the chemical bath to a desired temperature because the conventional apparatus only heats small portions of the chemicals at a time, i.e., those circulating through the sections of the pipe in which the halogen lamps are disposed.

### SUMMARY OF THE INVENTION

An object of the present invention is to provide a method of and apparatus for rapidly raising the temperature liquid used in manufacturing a semiconductor device.

Another object of the present invention is to provide a method of processing substrates with a high degree of productivity.

According to an aspect of the present invention, there is provided an apparatus comprising a chemical bath in which liquid to be heated is stored, circulation piping forming a loop with the chemical bath such that liquid can be circulated through the piping to and from the bath, and a heating system operatively associated with the circulation piping and with the chemical bath so as to heat the liquid present in the bath and so as to heat the liquid at a location between the point the liquid leaves the chemical bath and is returned to the chemical bath via the circulation piping.

To this end, the heating system includes a first heating unit associated with the circulation piping for heating the liquid that is being drawn from and returned to the chemical bath, a second heating unit for heating the liquid present in the chemical bath, at least one temperature sensor for measuring the temperature of the liquid in the chemical bath, and a controller for operating the first heating unit and the second heating unit according to the temperature of the liquid measured by the at least one temperature sensor.

In addition, the first heating unit comprises a case, heating piping extending through the case and connected at both ends thereof to the circulation piping so as to be disposed in-line with the circulation piping, and a microwave generator for generating microwaves used to heat the liquid passing through the heating piping. Preferably, the heating piping is made of a material through which the microwaves can be transmitted, i.e., a material that is substantially transparent with respect tot the microwaves. Also, the heating piping is preferably sinuous so as to have a plurality of curved sections. Still further, a shield extends along a wall of the case to prevent the microwaves from leaking from the case. The shield is preferably made of a metallic material.

The second heating unit comprises at least one microwave generator for generating microwaves used to heat the liquid present in the chemical bath. In this respect, the second heating unit may comprise a plurality of a microwave generators provided at different positions outside of the chemical bath. In this case, several temperature sensors are disposed at different positions inside the chemical bath. The controller selectively drives the microwave generators according to the respective temperatures measured by the temperature sensors. In addition, a shield extends over a wall of the chemical bath to prevent the microwaves from leaking out of the bath. The shield is preferably made of a metallic material.

According to another aspect of the present invention, there is provided a method of heating liquid comprising: preparing a chemical bath, circulating the liquid through the chemical bath by withdrawing the liquid from the chemical bath and subsequently returning the liquid to the chemical bath via circulation piping, and heating the liquid that is present in the bath and heating the liquid that is circulating outside the bath while the liquid is being circulated to and from the chemical bath via the circulation piping. Preferably, the liquid present in the chemical bath and the liquid flowing through the circulation piping are heated at the same time.

In addition, the temperature of the liquid in the chemical bath is measured, and the liquid is heated based on the measured temperature. The liquid that is flowing through the circulation piping is heated by generating microwaves and transmitting the energy of the microwaves to the liquid. Likewise, the liquid present in the chemical bath is heated by generating microwaves and transmitting the energy of the microwaves to the liquid. The microwaves may be generated at different positions outside the chemical bath. In this case, the temperature is sensed at different positions inside the chemical bath. The microwaves are selectively generated at the different positions according to the respective temperatures measured inside the chemical bath.

According to still another aspect of the present invention, a method of processing substrates using the heated liquid is provided. Thus, according to this aspect of the present invention, a chemical bath containing a liquid for treating the substrates is provided, the liquid is circulated through the chemical bath via circulation piping, the portion of the liquid that is present in the bath and the portion of the liquid that is present outside the bath, are separately heated until the temperature of the liquid reaches a desired temperature, and then the substrates are treated with the liquid at the desired temperature. For example, the substrates are cleaned, etched or rinsed by immersing the substrates in the liquid present in the chemical bath.

### BRIEF DESCRIPTION OF THE DRAWINGS

The above and other objects, features and advantages of the present invention will become more apparent inform the following detail description of the preferred embodiments thereof made with reference to the attached drawings in which:

FIG. 1 is a schematic diagram of an embodiment of an apparatus for heating liquid used in the manufacturing of a semiconductor device or the like according to the present invention;

FIG. 2 is an enlarged view of a section A of the apparatus shown in FIG. 1;

FIG. 3 is an enlarged view of a section B of the apparatus in FIG. 1;

FIG. 4 is a schematic diagram of another embodiment of an apparatus for heating liquid used in the manufacturing of a semiconductor device or the like according to the present invention; and

FIG. 5 is a flowchart of a method of heating liquid used in the manufacturing of a semiconductor device according to the present invention.

### DETAILED DESCRIPTION OF THE PREFERRED EMBODIMENTS

A method of and apparatus for heating liquid used in manufacturing a semiconductor device will now be described in detail with reference to the accompanying drawings. Like reference numerals denote like elements throughout the drawings.

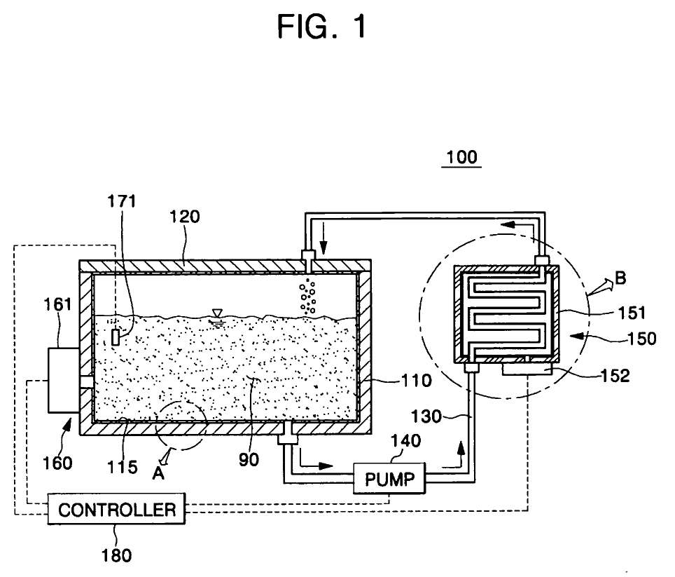

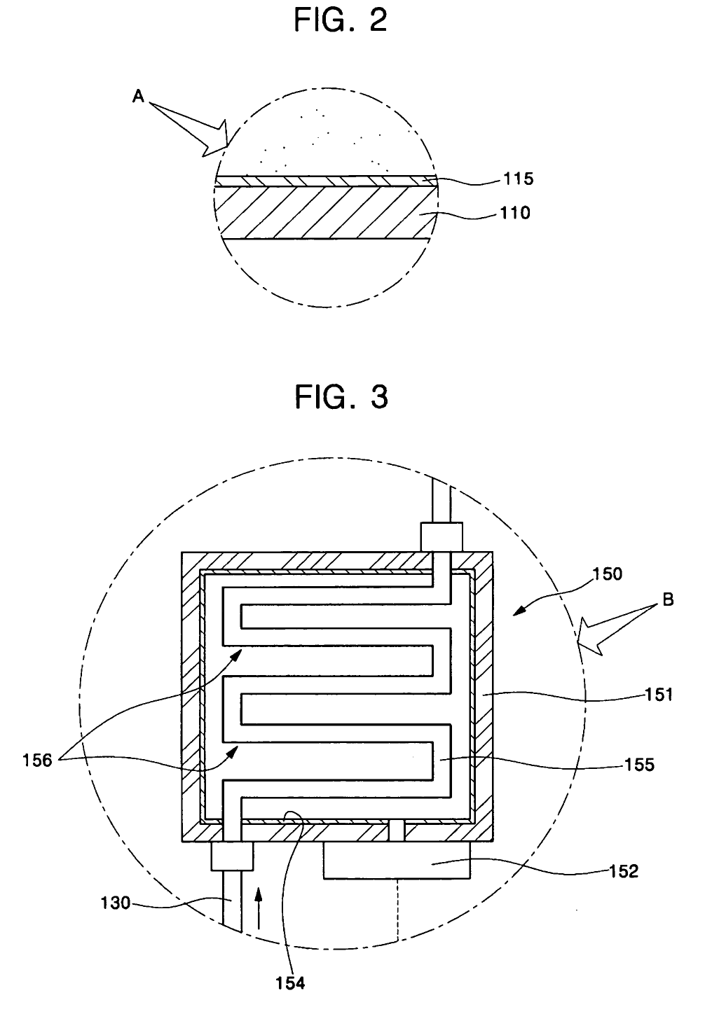

Referring first FIGS. 1 to 3, a first embodiment 100 of the apparatus includes a chemical bath 110, a circulation pipe 130 connected to the chemical bath 110, a heating system for heating the chemical in the chemical bath 110 together with the chemical in the circulation pipe 130.

More specifically, the chemical bath 110 defines a space in which chemicals or ultra pure water (hereinafter, referred to as a liquid 90) are contained. For instance, the chemical bath 110 comprises a tank having an open upper end. In addition, a cover 120 may be provided on the upper part of the chemical bath 110. The cover 120 may be opened and closed over the chemical bath 110. Preferably, the cover 120 covers the chemical bath 110 only when the liquid 90 in the chemical liquid bath 110 is being heated by the heating unit.

The circulation pipe 130 is configured to circulate the liquid 90 through the chemical bath 110. Thus, both ends of the circulation pipe 130 are connected to the chemical liquid bath 110. For example, one end of the circulation pipe 130 may be connected to the bottom of the chemical bath 110 and the other end of the circulation pipe 130 may be disposed at the top of the chemical bath 110. In addition, a pump 140 is disposed in the circulation pipe 130 to circulate the liquid 90.

The heating system includes a first heating unit 150 for heating the liquid 90 flowing through the circulation pipe 130, a second heating unit 160 for heating the liquid 90 in the chemical bath 110, a temperature sensor 171 for measuring the temperature of the liquid 90 in the chemical bath 110, and a controller 180 for operating the first heating unit 150 and the second heating unit 160 according to the temperature of the liquid 90 measured by the temperature sensor 171.

More specifically, the first heating unit 150 includes a case 151, a heating pipe 155 extending through the case 151 and connected at both ends thereof to the circulation pipe 130, and a microwave generator 152 for generating microwaves in the case 151. Thus, the liquid 90 circulated through the circulation pipe 130 passes through the heating pipe 155. As a result, the microwaves generated by the microwave generator 152 are transmitted to the liquid 90 flowing through the heating pipe 155. Accordingly, molecules of the liquid 90 are vibrated by the field of the microwaves. Therefore, the liquid 90 is heated by friction generated by the motion of the molecules of the liquid 90.

In addition, a shield 154 is disposed on an inner wall of the case 15i to prevent the microwaves from leaking out of the case 151. Preferably, the shield 154 is made of a metallic material. Also, the heating pipe 155 is made of a material through which the microwaves can be transmitted. For example, the heating pipe 155 is made of quartz. Moreover, the heating pipe 155 may include a plurality of curved portions 156 so as to be sinuous. Thus, a large length of the heating pipe 155 is accommodated by the case 151. Accordingly, a correspondingly great amount of the liquid 90 is present in the heating pipe 155 at any given time and thus, a large amount of the liquid 90 is heated by the microwaves.

The second heating unit 160 comprises a microwave generator 161 for generating microwaves in the chemical bath 110. The microwave generator 161 may be installed at one side of the chemical bath 110. Thus, the liquid 90 stored in the chemical liquid bath 110 is heated by the microwaves generated by the microwave generator 161. In addition, a shield 115 is formed on an inner wall of the chemical bath 110 and cover 120 to prevent the microwaves from leaking out. Preferably, the shield 115 is made of a metallic material.

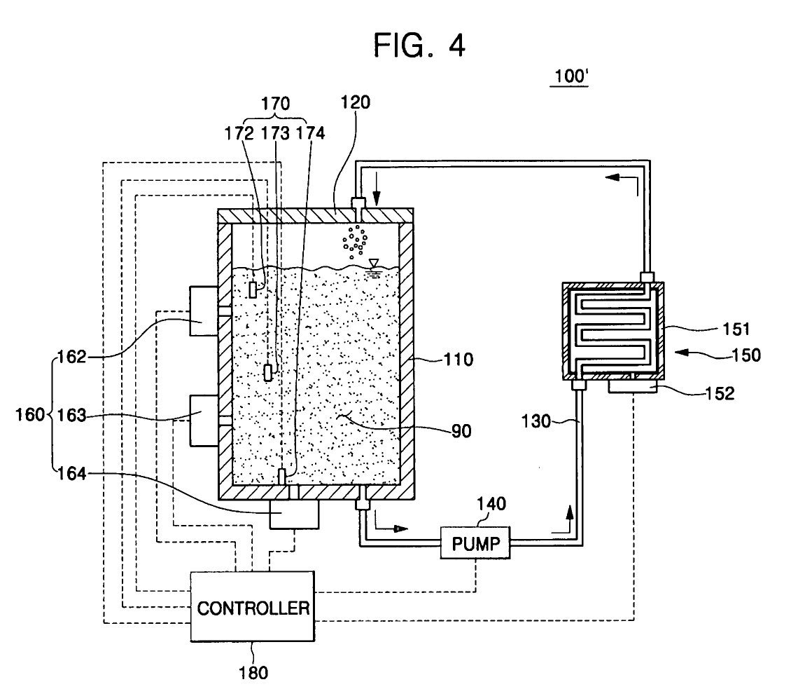

A second embodiment 100′ of an apparatus for raising the temperature of a liquid will now be described with reference to FIG. 4. The second embodiment 100′ is different from the first embodiment 100 with respect to the heating unit for heating the liquid 90 in the chemical bath 110. Therefore, basically only the heating system of the second embodiment of the apparatus 100′ for raising the temperature of liquid according to the present invention will be described in detail.

The heating system of the second embodiment includes a first heating unit 150 for heating the liquid 90 in the circulation pipe 130, a second heating unit 160 for heating different portions of the liquid 90 in the chemical bath 110, a temperature sensor 170 for measuring the temperature of the liquid 90 at different levels in the chemical bath 110, and a controller 180 for operating the first heating unit 150 and the second heating unit 160 according to the temperatures of the liquid 90 measured by the temperature sensor 170.

More specifically, the first heating unit 150 has the same structure as the first heating unit 150 of the first embodiment.

On the other hand, the second heating unit 160 comprises a plurality of microwave generators 162, 163, and 164 for generating microwaves in the chemical bath 110. Each of the microwave generators 162, 163, and 164 is installed at different positions outside of the chemical bath 110 so that different portions the liquid 90 in the chemical liquid bath 110 can be heated. For example, the microwave generators 162, 163, and 164 may be disposed at an upper part of the chemical bath 110, at a lower part of the chemical bath 110, and at the bottom of the chemical bath 110, respectively.

In addition, the temperature sensor 170 comprises a plurality of individual temperature sensors 172, 173, and 174 which sense the temperature of the liquid 90 at different positions in the chemical bath 110. For example, the temperature sensors 172, 173, and 174 may be disposed at different levels in the chemical bath 110. Preferably, the same number of temperature sensors 172, 173, and 174 and microwave generators 162, 163, and 164 are provided, and the temperature sensors 172, 173, and 174 are disposed adjacent to the microwave generators 162, 163, and 164 respectively. Therefore, in the illustrated embodiment, the temperature sensors 172, 173, and 174 are disposed at the upper part of the chemical bath 110, at the lower part of the chemical bath 110, and at the bottom part of the chemical bath 110, respectively. Furthermore, although the second embodiment has been illustrated and described as having three microwave generators and three corresponding individual temperature sensors, the present invention is not so limited; rather, other numbers of microwave generators and temperature sensors may be provided.

The controller 180 is respectively connected to the first and second heating units 150 and 160 and the temperature sensors 172, 173, and 174 so as to operate the microwave generator 152 of the first heating unit 150 and the respective microwave generators 162, 163, and 164 of the second heating unit 160 according to the temperatures of the chemical liquid 90 measured by the temperature sensors 172, 173, and 174. In particular, the controller 180 selectively operates the microwave generators 162, 163, and 164, according to the temperatures of the liquid 90 respectively measured by the temperature sensors 172, 173, and 174, to heat the liquid 90 uniformly in the chemical bath 110.

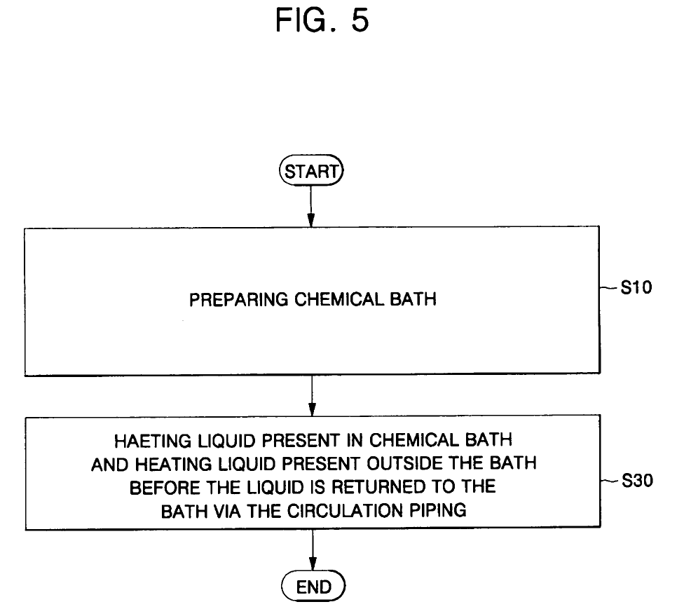

A method according to the present invention of heating liquid used in manufacturing a semiconductor device according will now be described in detail with reference to FIG. 5 and the schematic drawings of FIGS. 1-4.

First, the chemical bath of the apparatus 100 or 100′ is prepared (S10). For example, the tank of the chemical bath may be filled with liquid 90 (chemicals or ultra pure water) or the liquid 90 in the tank may be refreshed. Also, the lid 120 is closed to cover the tank. Then the liquid 90 is heated (S30). In this respect, an operator inputs a command to the controller 80 to initiate the heating process and as a result, the controller turns the pump 140 on. Thus, the liquid 90 is circulated through the circulation pipe 130 and chemical bath. At the same time, the controller 80 interacts with the heating system to heat the liquid 90.

In this case, the controller 180 preferably directs the heating system to heat the liquid 90 in the chemical liquid bath 110 and to heat the liquid 90 flowing through the circulation pipe 130 at the same time.

In the case of the first embodiment 100, the temperature of the liquid 90 in the chemical liquid bath 110 is measured by the temperature sensor 171 and a signal representative thereof is issued to the controller 180. The controller 180 then selectively operates the first heating unit 150 and the second heating unit 160 according to the temperature of the liquid 90 measured by the temperature sensor 171. Specifically, the microwave generator 152 and/or the microwave generator 161 is/are operated to heat the liquid 90 until the liquid 90 attains a desired temperature, e.g., a temperature most effective for the cleaning process. In addition, once the liquid 90 attains the desired temperature, the microwave generator 152 and/or the microwave generator 161 is/are operated to maintain the liquid at the desired temperature.

Next, the controller 180 may shut down the operation of the pump 140 and the heating system. At this time the lid 120 is opened and a batch of substrates is immersed in the liquid so as to be processed, e.g., so as to be cleaned, etched or rinsed by the liquid 90.

The operation is similar with respect to the case of the second embodiment 100′ of the apparatus for heating the liquid according to the present invention. In the case of the second embodiment, however, the controller 180 receives signals from the temperature sensors 172, 173, and 174, and which signals are representative of the temperature of the liquid 90 at different positions in the chemical bath 110. In this case, the microwave generators 162, 163, and 164 are respectively operated according to the respective temperatures measured by the temperature sensors 172, 173, and 174 to rapidly and uniformly heat the liquid 90.

Accordingly, in a method of and apparatus for heating liquid used in a process such as a process of cleaning semiconductor wafers, the liquid in a chemical bath and the liquid flowing through a circulation pipe may be heated at the same time so that the temperature of the liquid can be rapidly raised to a temperature at which the liquid is most effective for carrying out the process.

Also, the liquid is heated using microwaves in the method and apparatus according to the present invention. Thus, the liquid can be rapidly heated to the desired temperature. Therefore, the present invention enhances the productivity of the process and the yield of highly reliable devices.

Finally, although the present invention has been particularly shown and described with reference to the preferred embodiments thereof, the present invention is not so limited. Accordingly, various changes to and modifications of the preferred embodiments, as will be apparent to those skilled in the art, are seen to be within the true spirit and scope of the present invention as defined by the appended claims.

What is claimed is:

1. Apparatus for heating liquid used in processing a substrate, the apparatus comprising:
a chemical bath in which the liquid is to be stored;
circulation piping connected to the chemical bath and forming a loop therewith such that liquid can be circulated through the piping to and from the bath; and
a heating system including a first heating unit operatively associated with the circulation piping so as to heat liquid flowing therethrough at a location between the point the liquid leaves the chemical bath and is returned to the chemical bath via said piping, and a second heating unit operatively associated with the chemical bath so as to heat the liquid present in the bath.

2. The apparatus according to claim 1, wherein the heating system further comprises:
at least one temperature sensor positioned so as to sense the temperature of the liquid in the chemical bath; and
a controller operatively connected to the temperature sensor, the first heating unit and the second heating unit so as to operate the first heating unit and the second heating unit according to the temperature of the liquid measured by each said at least one temperature sensor.

3. The apparatus according to claim 2, wherein the first heating unit comprises:
a case disposed in-line with the circulation piping; and
heating piping extending through the case and having ends connected to the circulation piping so as to be disposed in-line with respect to the circulation piping; and
a microwave generator that generates microwaves and is disposed relative to the case such that the microwaves are provided within the heating piping extending through the case, whereby the microwaves heat the liquid flowing through the heating piping.

4. The apparatus according to claim 3, wherein the heating piping is of a material substantially transparent to the microwaves.

5. The apparatus according to claim 3, wherein the heating pipe is sinuous.

6. The apparatus according to claim 3, wherein the first heating unit further comprises a shield extending along a wall of the case, the shield being of a material that is substantially opaque with respect to the microwaves to prevent the microwaves from leaking out of the case.

7. The apparatus according to claim 2, wherein the second heating unit comprises at least one microwave generator that generates microwaves and is disposed relative to the chemical bath such that the microwaves are provided in the chemical bath to heat the liquid in the chemical bath.

8. The apparatus according to claim 7, wherein the at least one microwave generator comprises a plurality of microwave generators disposed at different positions outside the chemical bath.

9. The apparatus according to claim 8, wherein the at least one temperature sensor comprises a plurality of temperature sensors disposed at different positions inside the chemical bath.

10. The apparatus according to claim 7, wherein the second heating unit comprises a shield extending along a wall of the chemical bath, the shield being of a material that is substantially opaque with respect to the microwaves to prevent the microwaves from leaking out of the bath.

11. A method of heating liquid used in the processing of a substrate, the method comprising:
providing a chemical bath containing a liquid for treating substrates;
circulating the liquid through the chemical bath by withdrawing the liquid from the chemical bath and subsequently returning the liquid to the chemical bath via circulation piping;
while the liquid is being circulated to and from the chemical bath via the circulation piping, heating the liquid that is present in the bath; and
while the liquid is being circulated to and from the chemical bath via the circulation piping, heating the liquid that is present outside the bath before the liquid flows back into the bath through the circulation piping.

12. The method according to claim 11, wherein the liquid present in the chemical bath and the liquid flowing through the circulation piping are heated at the same time.

13. The method according to claim 11, further comprising measuring the temperature of the liquid in the chemical bath, and
wherein the liquid present in the chemical bath and the liquid flowing through the circulation piping are heated based on the measured temperature of the liquid in the chemical bath.

14. The method according to claim 11, wherein the heating of the liquid that is flowing through the circulation piping comprises generating microwaves and transmitting the energy of the microwaves to the liquid.

15. The method according to claim 11, wherein the heating of the liquid present in the chemical bath comprises generating microwaves and transmitting the energy of the microwaves to the liquid present in the chemical bath.

16. The method according to claim 15, wherein the microwaves are generated at different positions outside the chemical bath.

17. The method according to claim 18, wherein the temperature is sensed at different positions inside of the chemical bath.

18. A method of processing substrates, comprising:
providing a chemical bath containing a liquid for treating the substrates;
circulating the liquid through the chemical bath by withdrawing the liquid from the chemical bath and subsequently returning the liquid to the chemical bath via circulation piping, whereby a portion of the liquid is present in the bath and another portion of the liquid is present outside the bath;
while the liquid is being circulated to and from the chemical bath via the circulation piping, heating the portion of the liquid that is present in the bath, and separately heating the portion of the liquid that is present outside the bath, until the temperature of the liquid reaches a desired temperature; and
subsequently treating the substrates with the liquid.

19. The method according to claim 18, wherein the heating of the liquid present in the bath and/or that is present outside the bath comprises generating microwaves and transmitting the energy of the microwaves to the liquid.

20. The method according to claim 18, wherein the treating of the substrates comprises immersing the substrates in the liquid in the bath.
